(19) United States
(12) Patent Application Publication
(10) Pub. No.: US 2017/0371987 A1
(43) Pub. Date: Dec. 28, 2017

(54) Statistically Consistent Past, Present, and Forecast Weather Time-Series for Geographic Points

(71) Applicant: Weather Source LL, Salem, NH (US)

(72) Inventor: Mark Joseph Gibbas, Amesbury, MA (US)

(21) Appl. No.: 15/581,351

(22) Filed: Apr. 28, 2017

Related U.S. Application Data
(60) Provisional application No. 62/355,793, filed on Jun. 28, 2016.

(51) Int. Cl. G06F 17/50

(52) U.S. Cl. CPC G06F 17/5009; G06F 2217/16

(57) ABSTRACT

Methods and systems to construct models to transform weather information of one source to be statistically consistent with weather information of another source (i.e., to compensate for statistical differences/bias between the sources), without necessarily having to determine or compute the actual bias.

### BACKGROUND

It may be useful to utilize weather information of multiple sources (e.g., observed and/or forecast weather information), such as to construct a more robust database of weather information for a particular location, and/or to predict or forecast future weather for the location.

Weather information of one source may, however, be inherently biased relative to weather information of another source due to differences in observation/measurement equipment, locations (latitude, longitude, and/or elevation of observation/measurement equipment), and/or computational algorithms (e.g., forecasting methodology), of the respective sources.

### BRIEF DESCRIPTION OF THE DRAWINGS/FIGURES

FIG. 1 is an example elevation map of geographically dispersed sources of weather information, which may have inherently biases (e.g., statistical differences), relative to one another.

FIG. 2 is a flowchart of a method of providing statistically consistent time-series of historical, real-time, and/or forecast weather information.

FIG. 3 is block diagram of an apparatus to provide statistically consistent time-series of historical, real-time, and/or forecast weather information.

FIG. 4 is a block diagram of a computer system configured to provide statistically consistent time-series of historical, real-time, and/or forecast weather information.

FIG. 5 is an illustration of example pseudo-code to process forecast/observation pairs.

FIG. 6 is a flowchart of a method of determining a model to render weather information of a secondary source statistically consistent with weather information of a primary source, for one of multiple time slots of a day of year.

FIG. 7 is an illustration of a weather information aggregation window DOY_W of n consecutive days, centered about a day of year (DOY).

FIG. 8 is an expanded view of the illustration of FIG. 7, in which the window DOY_W is illustrated as n=21 consecutive days, centered about the DOY.

FIG. 9 is an illustration of a set of aggregated weather information for a time-slot of a DOY (e.g., hour 1 of January 11).

FIG. 10 is an illustration aggregated weather information for a time-slot (e.g., from 1:00 AM through 6:00 AM, of January 11).

FIG. 11 is a block diagram of an apparatus/system to provide a weather model for each of multiple time-slots of one or more days of year based on m years of weather information from a primary source, and m corresponding years of weather information from a secondary source.

FIG. 12A illustrates a statistical distribution of measurements of a weather parameter (e.g., temperature) of a primary data set.

FIG. 12B illustrates a statistical distribution of measurements of the weather parameter of a secondary data set.

FIG. 12C illustrates a statistical distribution of transformed measurements of the weather parameter of the secondary data set, which matches the statistical distribution of measurements of the weather parameter of the primary data set of FIG. 12A.

FIG. 13 is a block diagram of an apparatus/system to supplement weather information of a primary source with transformed weather information of one or more secondary sources.

FIG. 14 is a block diagram of an apparatus/system to identify and compensate for missing and/or outlier weather information/data points of a primary source of weather information.

In the drawings, the leftmost digit(s) of a reference number identifies the drawing in which the reference number first appears.

### DETAILED DESCRIPTION

For illustrative purposes, example uses of weather information are described below. Methods and systems disclosed herein are not, however, limited to the examples below.

Historic weather information for a locale may be used to construct a weather forecast model to predict future weather for the locale based on more recent weather information. If the source of the historic weather information and the source of the more recent weather information differ in any respect (e.g., different observation/measurement equipment and/or different locations of observation/measurement equipment), however, there may be a bias, or difference between the predicted future weather and the actual future weather.

A correlation between historic business performance information, such as sales numbers, and corresponding historic weather information may be used to construct a model to predict future business performance information based on predicted future weather (e.g., using a weather forecast model). The predicted future business performance information may be used for business/financial decisions regarding inventory, prices/discounts, investments, and/or risk mitigation. If the source of the historic weather information and the source of the current weather information differ in any respect, however, a bias may be introduced between the predicted future business performance information and actual (future) business performance information.

Weather information from multiple sources may be combined, such as to supplement weather information of a first source with weather information of a second source. Weather information of the second source may, however, be inherently biased relative to weather information of the first source due to differences in observation/measurement equipment, locations (latitude, longitude, and/or elevation), and/or computational algorithms of the respective sources.

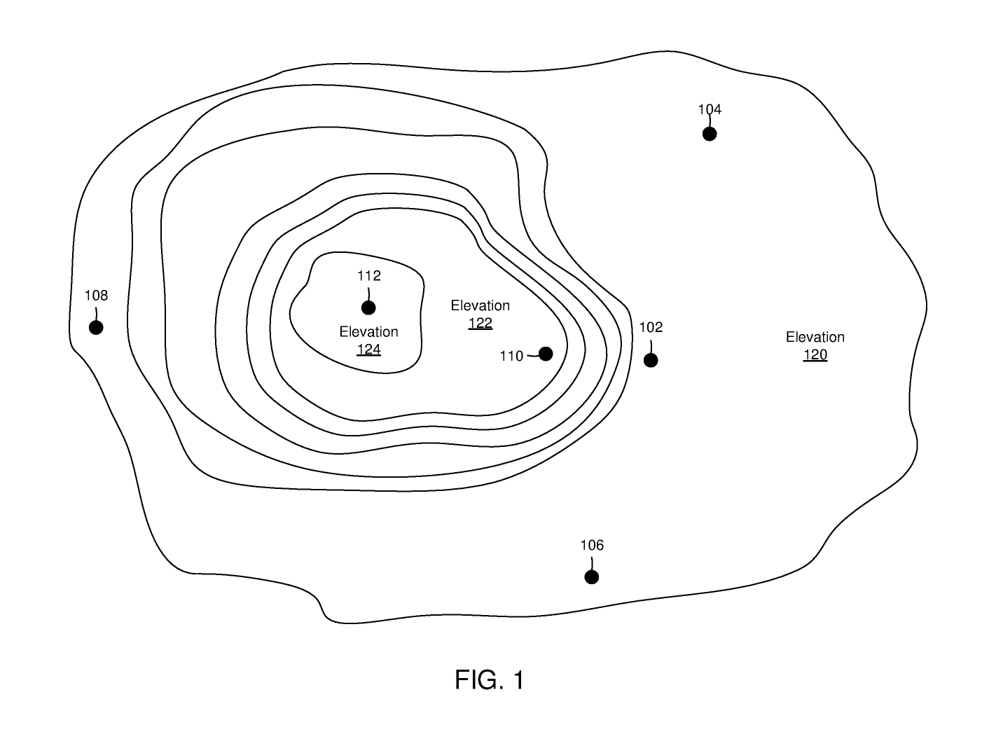

FIG. 1 is an example elevation map 100 of locations 102 through 112, which are geographically dispersed relative to one another (longitudinally and/or laterally).

Locations 102, 104, 106, and 108, are at a first elevation 120. Elevation 120 may be, for example and without limitation, sea level. Location 110 is at a second elevation 122, and location 112 is at a third elevation 124. Elevation 110 may be higher than elevation 120, and elevation 124 may be higher than elevation 122. Alternatively, elevation 122 may be lower than elevation 120, and elevation 124 may be lower than elevation 122.

Table 1 below lists sources of weather information, A through F, for respective locations 102-112. One or more of the sources may include and/or provide weather information that has been observed or measured at or proximate to the respective location, and/or may include or provide forecast/predicted weather information for the location.

TABLE 1

| Source | Location |
|---|---|
| A | 102 |
| B | 104 |
| C | 106 |
| D | 108 |
| E | 110 |
| F | 112 |

Due to proximity of locations 102 through 112, relative to one another, weather information of sources A through F, for a given point in time and/or over a range of time, may be similar to one another, but may not necessarily be identical to, or statistically consistent with one another. There may be, for example, differences (i.e., a bias) in temperature, wind velocity (i.e., direction and/or speed), pressure, humidity, and/or other weather parameter(s).

As an example, where weather information regarding location 102 is of interest, source A may be designated a primary source of weather information and one or more of sources B through F may be designated a secondary source. Source A may be designated the primary source based on location 102 and/or contents of source A (e.g., quantity and/or quality of weather information available from source A). In this example, weather information of each of sources B through F (i.e., regarding locations 104 through 112), may be biased relative to weather information of source A (i.e., regarding location 102), due to differences in location (e.g., latitude, longitude, and/or elevation), equipment, and/or algorithms.

To compensate for (i.e., remove and/or eliminate) bias, models are generated to transform weather information of one source to be statistically consistent with weather information of another source, without necessarily having to determine or compute the actual or specific bias.

Unless indicated otherwise herein, the term “weather forecast data source” refers to weather forecast data provided by a specific weather forecasting system or source. Examples of a weather forecast data include numerical model forecasts produced by government forecasting centers, forecasts produced by government organizations such as the U.S National Weather Service (NWS), and/or forecasts produced by commercial weather forecasting companies.

Unless indicated otherwise herein, the term “weather forecast time-series” refers to a dataset representing a geographic point where weather forecast data is collected into a time-series such that the data in the time-series comes from the earliest portion of the forecast data source. For example, a forecast initialized from a point in time will typically provide predicted values for weather parameters on regular time-steps many hours or days in the future. Forecast weather values that are the closest to the initialization time of the forecast may be collected and saved. This may be referred to as zero-hour forecast, or zero-hour analysis. If a zero-hour analysis is not available, forecasted weather information for the forecast time-step closest to the forecast initialization time may be collected and saved. The forecast data collection process provides a time-series of forecast source data that naturally has the greatest correlation to weather that actually occurred.

A weather forecast time-series is associated with a specific geographic point. Numerous geographic points may be supported by a weather forecast data source.

Unless indicated otherwise herein, the term “weather observation data source” refers to a dataset provided by a specific source that measures and/or analyzes weather conditions and records values of the conditions. Weather measurement systems are one common source of weather observation data. Weather measurement systems may include, without limitation, weather monitoring stations such as NWS Automated Surface observing System (ASOS) stations, radar observations, satellite observations, wind profiler observations, and/or other system(s) that monitor and record weather values.

Another viable source of weather observations comes from weather analysis computer programs designed to produce a meteorological analysis of weather values over a spatial grid, given various weather observations as input. In the meteorological community these analysis models are often referred to as ‘reanalysis’ models to distinguish them from forecast models which also have an analysis component. Reanalysis models produce an analysis of weather conditions over a geographic region and over a period of time.

Unless indicated otherwise herein, the term “weather observation time-series” refers to weather information collected over time from a specific weather information source and for a specific geographic point.

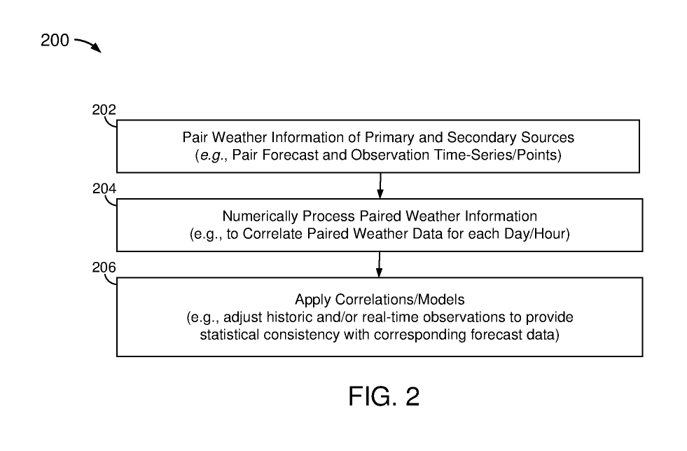

FIG. 2 is a flowchart of a method 200 of providing statistically consistent time-series of historical, real-time, and/or forecast weather information.

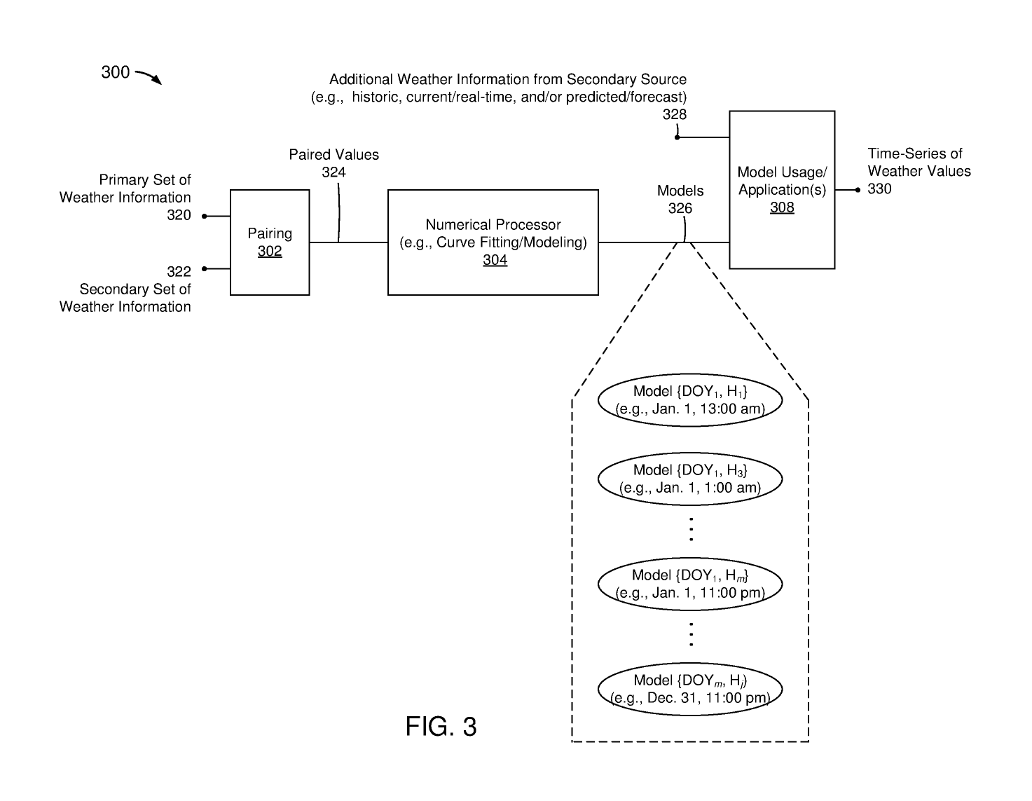

FIG. 3 is block diagram of an apparatus 300 to provide statistically consistent time-series of historical, real-time, and/or forecasted weather information. Apparatus 300 may include, without limitation, circuitry, a machine, a computer system, a processor and memory, a computer program encoded within a computer-readable medium, and/or combinations thereof. Circuitry may include discrete and/or integrated circuitry, application specific integrated circuitry (ASIC), a system-on-a-chip (SOC), and combinations thereof.

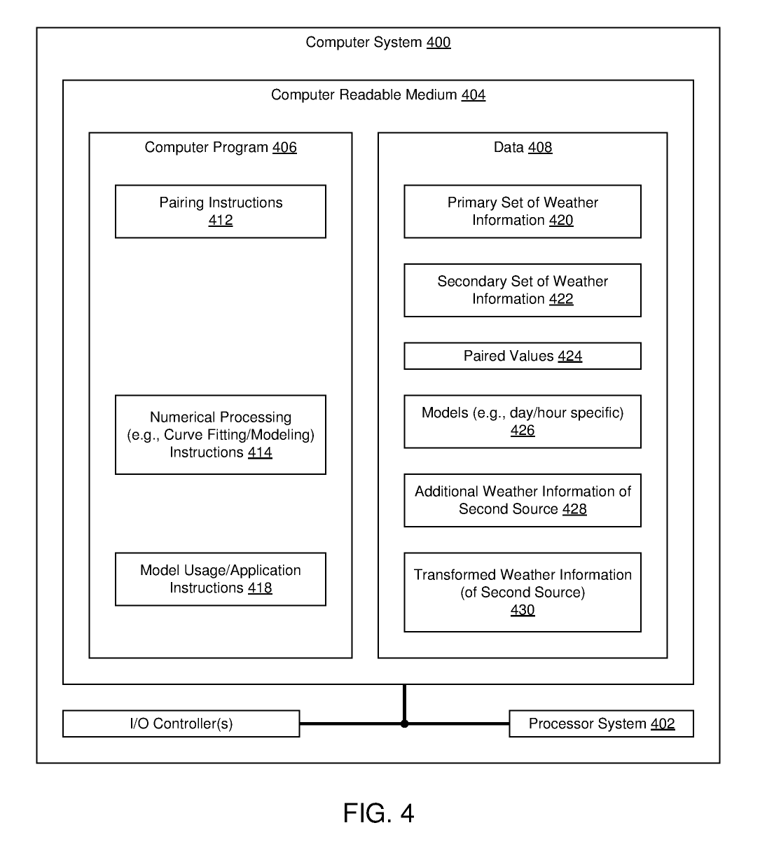

FIG. 4 is a block diagram of a computer system 400 to provide statistically consistent time-series of historical, real-time, and/or forecasted weather information. Computer system 400 includes one or more processors, illustrated here as a processor 402, to execute instructions of a computer program 406 encoded within a computer readable medium 404. Computer readable medium 404 may include a transitory or non-transitory computer-readable medium. Computer readable medium 404 includes data 408, which may be used by processor 402 during execution of computer program 406, and/or generated by processor 402 during execution of computer program 406.

FIGS. 2-4 are described below with reference to an example in which a primary set of weather information includes historical weather information, and a secondary set of weather information includes forecast weather information. FIGS. 2-4 are not, however, limited to this example.

One or more of the foregoing embodiments (i.e., FIGS. 2-4), may utilize weather information (e.g., historical/observed) from a primary source, covering a period of time of one year or more, and at least one year of weather information from a secondary source (e.g., forecast), that overlaps at least a one-year period of the weather information of the primary source. In practice, it may be useful to use numerous sets of weather information of the primary and secondary sources (e.g., historical and forecast datasets), over a period of several years.

### Paring Weather Information/Points of Primary and Secondary Sources (202, 302, 412)

The geographic arrangement of forecast points and observation points may be assumed to be constant over time, however, the forecast points and observation points may or may not be spatially co-located such that there is a perfect one-to-one spatial overlapping of forecast and observation points.

To provide statistically consistent past, present, and forecast weather time-series for geographic points, forecast and observation points are paired such that the points are as meteorologically consistent with one another as possible.

If the forecast and observation points are co-located to a common set of geographic points, then the co-located forecast and observation points may be simply matched up as pairs (324, 424) for the computations in creating statistically consistent past, present, and forecast weather time-series.

If the forecast and observation points are not co-located, an exercise may be conducted to match up the forecast and observation points such that the paired points (324, 424) are as close to each other as possible while also being physically as consistent as possible (e.g., in terms of elevation, land, and/or water surface type).

### Numeric Processing Framework (204, 304, 414)

A numeric processing framework processes each set of paired forecast and observation time-series that are time synchronized covering a period of one year or more. The time processing interval may be any consistent interval. Examples are provided herein with respect to sequential days and hours. A goal of the numeric processing framework is to collect subsets of weather information from time-series that are seasonally meteorologically consistent, and use the data subset to create numeric equations (e.g., construct/train/evaluate model(s)), to relate the observation data to the forecast data.

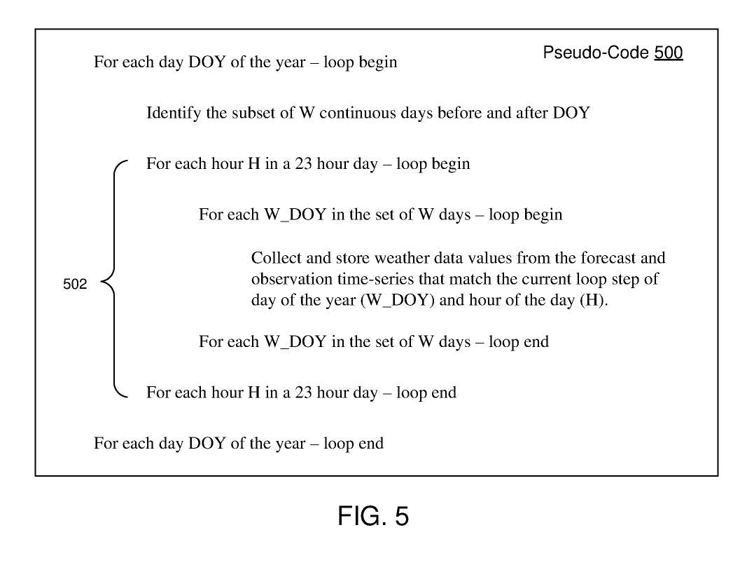

FIG. 5 is an illustration of example pseudo-code 500 to process forecast/observation pairs.

In FIG. 5, DOY (day-of-year), is an integer from 1 to 366, to account for the maximum number of days in a year including leap years. In processing each DOY, all available years are considered in the processing. For example, for DOY=1, January 1st from all available years are processed. The variable W defines a window around the DOY that will be processed. Window W may be an integer from 0 to 182. In some situations, W values of 7 to 14 days may provide suitable (e.g., better/best) results.

In an example, where 5 years of overlapping forecast and observation data are processed, with W=10 (i.e., for a total window of 21 days), a subset collection may have 105 sets of paired forecast and observation weather values.

To increase the sample size, an additional loop may be provided (e.g., within an hour-processing loop 502 of pseudo-code 500), to add an N hours of data before and after the target hour (i.e., before and after each respective hour of loop 502). Setting N to 1 may triple the sample size. Values of N greater than 6 may have a negative impact (e.g., where there may exist significant diurnal variation).

The collected paired values from all available weather parameters are then processed via a suite of curve fitting tests to determine the best numerical relationship between the forecast and observation data for each day of the year and hour of the day.

The numeric processing may include curve fitting tests and curve selection.

For example, various weather elements from the collected forecast and observation subsets (324, 424), may be processed with a suite of curve fitting tests to determine the most accurate numeric relationship between the forecast and observation data. The suite of tests may include, without limitation, linear regression models, quadratic regression models, and/or b-spline models. The observation data is processed through the models to produce estimates for what the forecast data should be. These estimates are then compared to the actual forecast data and tested via ‘goodness of fit’ tests such as R-squared and root mean squared error (RMSE). The simplest model with the best goodness of fit is selected as the model to relate observation data to forecast data.

### Application/Usage of Model(s) (206, 308, 418)

Models constructed as disclosed herein may be used/applied in one or more of a variety of applications. A model constructed as described in the example above may, for example, be used to adjusting past observations to be statistically consistent with forecast data. In this example, using the numerical models (326, 426) produced in the numeric processing/curve fitting (204, 326, 426), the full history (e.g., years or decades) of observations (328, 428), may be processed through the selected models (326, 426) to produce a time-series of weather values (330, 430), that are statistically consistent with the forecast data with which the observations were paired.

Real-time values from the paired observation dataset may also be processed via the models (326, 426), to produce a continuous source of updated data (330, 430). The resulting dataset can reach much further back in time than the original forecast data source. Because the resulting dataset is now statistically consistent with the forecast data, users can then build weather business models tuned precisely to be driven by the forecasts.

### Further Data Aggregation and Model Generation Examples

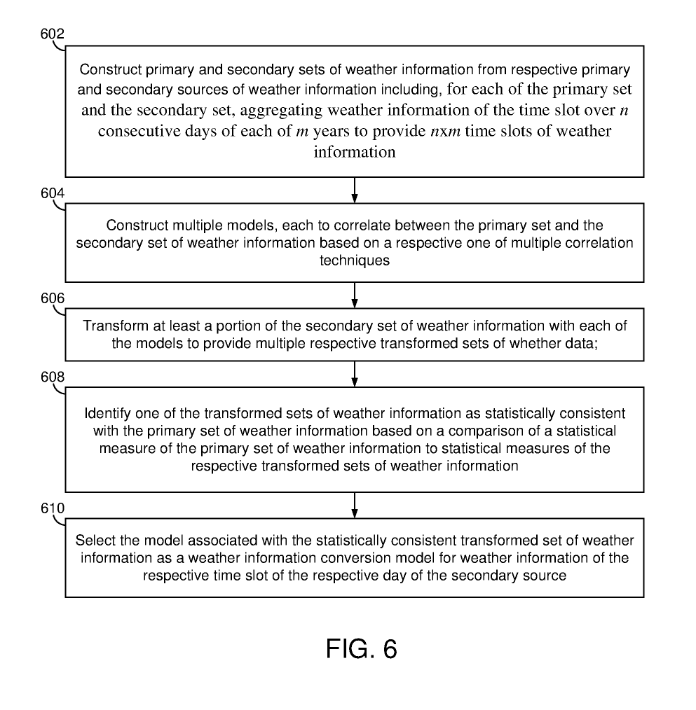

FIG. 6 is a flowchart of a method 600 of determining a model to render weather information of a secondary source statistically consistent with weather information of a primary source, for one of multiple time slots of a day of year. Method 600 may be performed with respect to each of multiple time slots of each of multiple days of year.

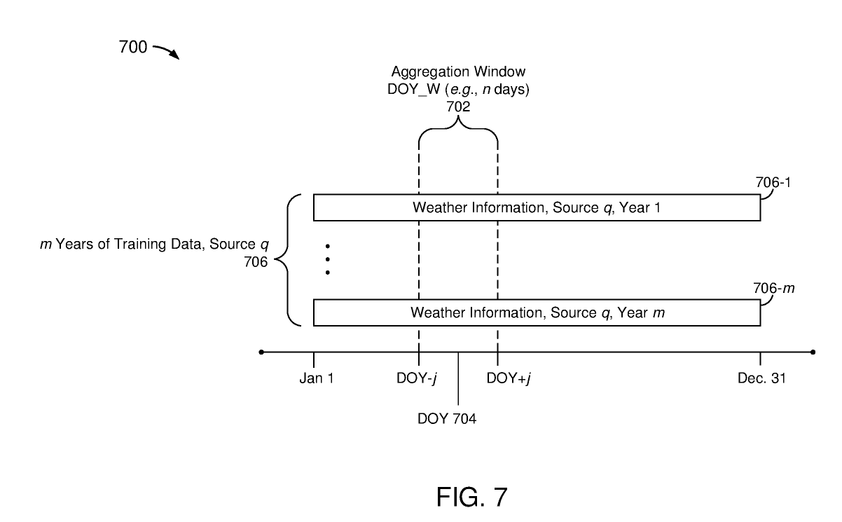

Method 600 is described below with reference to FIGS. 7-9. Method 600 is not, however, limited to the example of any of FIGS. 7-9.

At 602, a primary set and a secondary set of weather information is constructed from respective primary and secondary sources of weather information. This includes, for each of the primary set and the secondary set of weather information, aggregating weather information of the time slot over n consecutive days of each of m years to provide nxm time slots of weather information, where each of n and m is an integer greater than 1.

FIG. 7 is an illustration 700 of a weather information aggregation window DOY_W 702 of n consecutive days, centered about a day of year (DOY) 704. Illustration 700 further includes m years of weather information 706 of a source q. Source q may represent a primary or a secondary source of weather information.

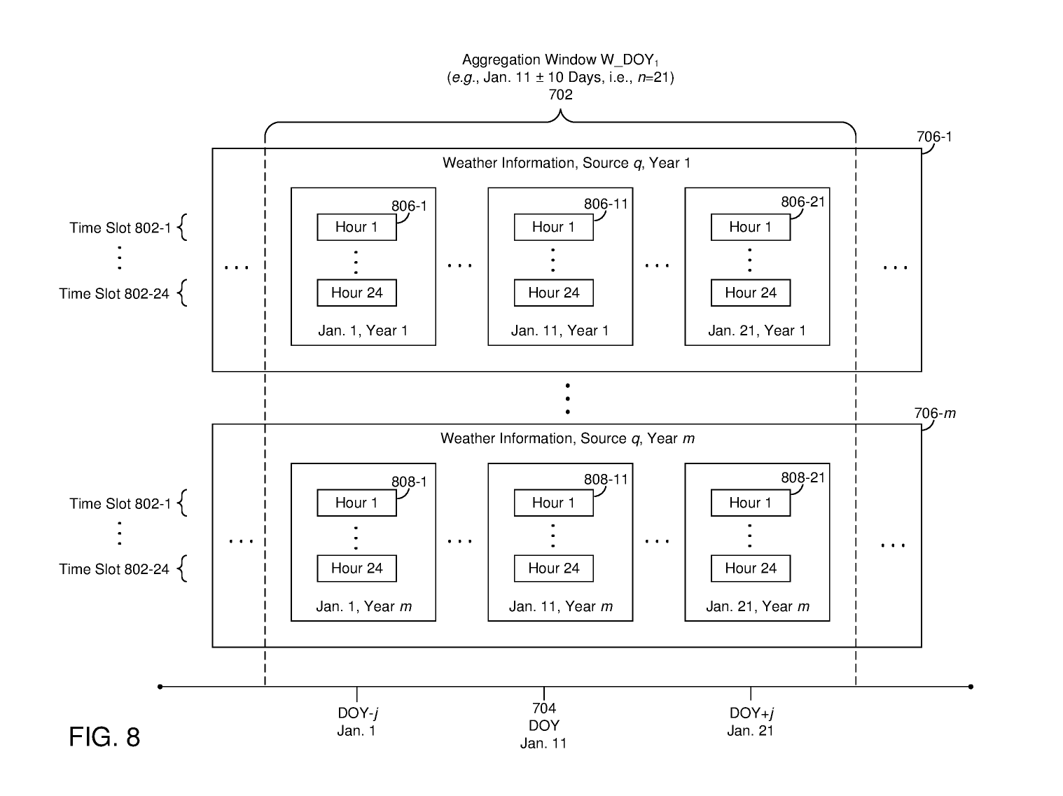

FIG. 8 is an expanded view 800 of illustration 700, in which window 702 DOY_W 702, illustrated here as n=21 consecutive days, is centered about DOY 704, illustrated here as January 11.

In the example of FIG. 8, source q includes multiple time slots of weather information, illustrated here as twenty-four (24) one-hour time-slots of weather information 802-1 through 802-24. Methods and systems disclosed herein are not, however, limited to hourly time slots.

Further in the example of FIG. 8, time slot of weather information 802-1 includes time slots 806-1 through 806-21 of year 1, and time slots 808-1 through 808-21 of year m.

In accordance with 602 of method 600, for each of time slots 802-1 through 802-24 of DOY 704, weather information of source q (i.e., source q as a primary or as a secondary source of weather information), is aggregated over n=21 consecutive days of years 704-1 through 704-m, to provide nxm time slots of weather information (e.g., 21×m time slots of weather information).

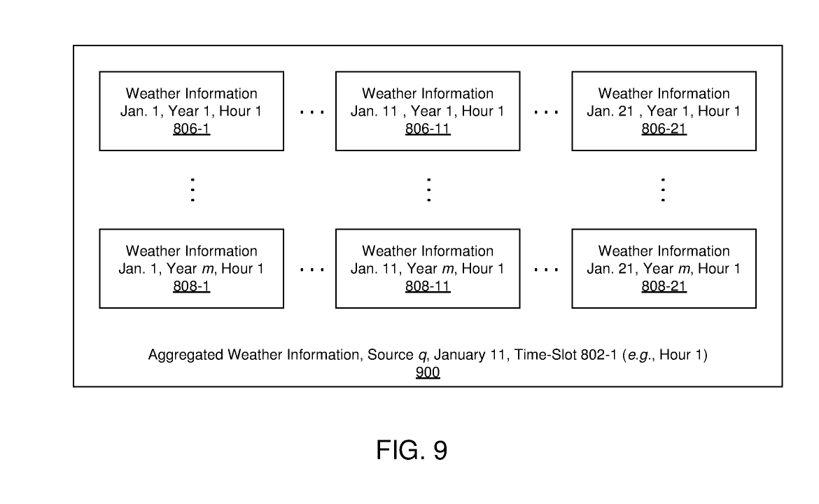

FIG. 9 is an illustration of a set of aggregated weather information (set) 900 for time-slot 802-1 of DOY 704 (i.e., hour 1 of January 11). Set 900 includes time slots 806-1 through 806-21 of January 1 through January 21, for each of years 1 through m. Set 900 may represent a primary set of weather information or a secondary set of weather information of the time-slot.

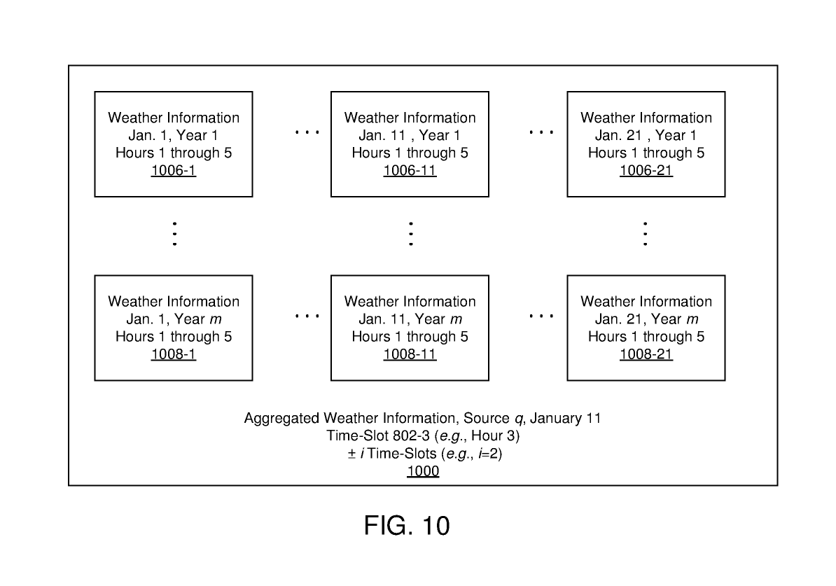

In an embodiment, the aggregating at 602 includes aggregating weather information of the time slot and of one or more additional/adjacent time slots (e.g., a time slot ±i adjacent time-slots), to provide (2j+1)×m time slots of weather information. This is illustrated below with reference to FIG. 10.

FIG. 10 is an illustration of an example of aggregated weather information 1000 for a time-slot 802-3. Time-slot 802-3 may represent, for example, a one-hour time slot from 3:00 AM to 4:00 AM, of January 11.

In the example of FIG. 10, aggregated weather information 1000 includes n=21 subsets of weather information 1006-1 through 1006-21 for year 1, and n=21 subsets of weather information 1008-1 through 1008-21 for year m. Each subset of weather information 1006-1 through 1006-21, and 1008-1 through 1008-21 includes five (5) time slots of weather information (i.e., hours 1 through 5), which may be centered about time-slot 802-3. Where time slot 802-3 corresponds to 3:00 AM to 4:00 AM, each subset of weather information 1006 and 1008 may include weather information for 2 hours preceding time-slot 802-3, and weather information for 2 hours subsequent to time-slot 802-3.

Returning to method 600 in FIG. 6, at 604, multiple models are constructed, each to correlate between the primary set and the secondary set of weather information based on a respective one of multiple correlation techniques, such as described in one or more examples herein.

At 606, at least a portion of the secondary set of weather information is transformed with each of the models to provide multiple respective transformed sets of weather data. With reference to FIG. 9, where set 900 represents a secondary set of weather information, at least a portion of set 900 is transformed with each of multiple models to provide multiple respective transformed sets of weather data.

At 608, one of the transformed sets of weather information is identified as statistically consistent with the primary set of weather information based on a comparison of a statistical measure of the primary set of weather information to statistical measures of the respective transformed sets of weather information, such as described in one or more examples herein.

At 610, the model associated with the statistically consistent transformed set of weather information is selected as a weather information conversion model for the respective time slot of the respective day of the secondary source.

In an embodiment, method 600 may be used to provide 24 hourly models for each day of year.

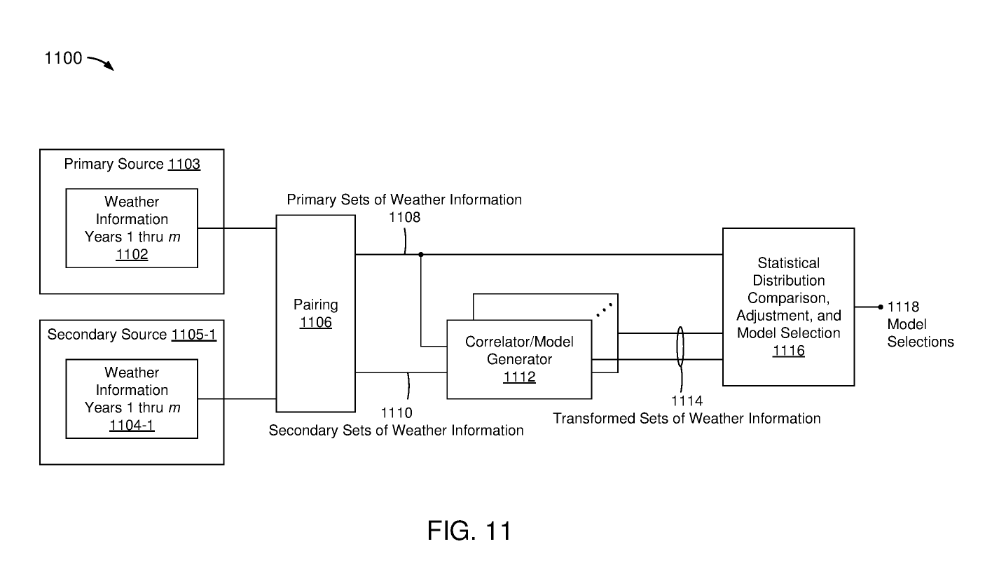

FIG. 11 is a block diagram of a system 1100 to provide a weather model for each of multiple time-slots of one or more days of year based on m years of weather information 1102 from a primary source 1103, and m corresponding years of weather information 1104 from a secondary source 1105.

System 1100 includes a pairing engine 1106 to construct a primary set of weather information 1108 and a secondary set of weather information 1110 for each time-slot of each day of year, such as described above with reference to 602 in FIG. 6.

System 1100 further includes multiple correlator/model generators 1112, each to construct a model to correlate between each primary set of weather information 1108 and corresponding secondary set of weather information 1110, based on a respective one of multiple correlation techniques, such as described above with reference to 604 in FIG. 6. Each correlator/model generator 1112 may be configured to generate a model for each time-slot of each day of year.

Each correlator/model generator 1112 may be further configured to transform at least a portion of the respective secondary set of weather information 1110 to provide a respective transformed set of weather data 1114, such as described above with reference to 606 in FIG. 6.

System 1100 further includes a statistical distribution comparison, adjustment, and model selection engine 1116 to identify one of the transformed sets of weather information 1114, for each time-slot of each day of year, as statistically consistent with the respective primary set of weather information 1108 based on a comparison of a statistical measure of the primary set of weather information 1108 to statistical measures of the respective transformed sets of weather information 1114, such as described above with reference to 608 in FIG. 6

Engine 1116 may be configured to output a model selection 1118 for each time slot of each day of year, such as described above with reference to 610 in FIG. 6.

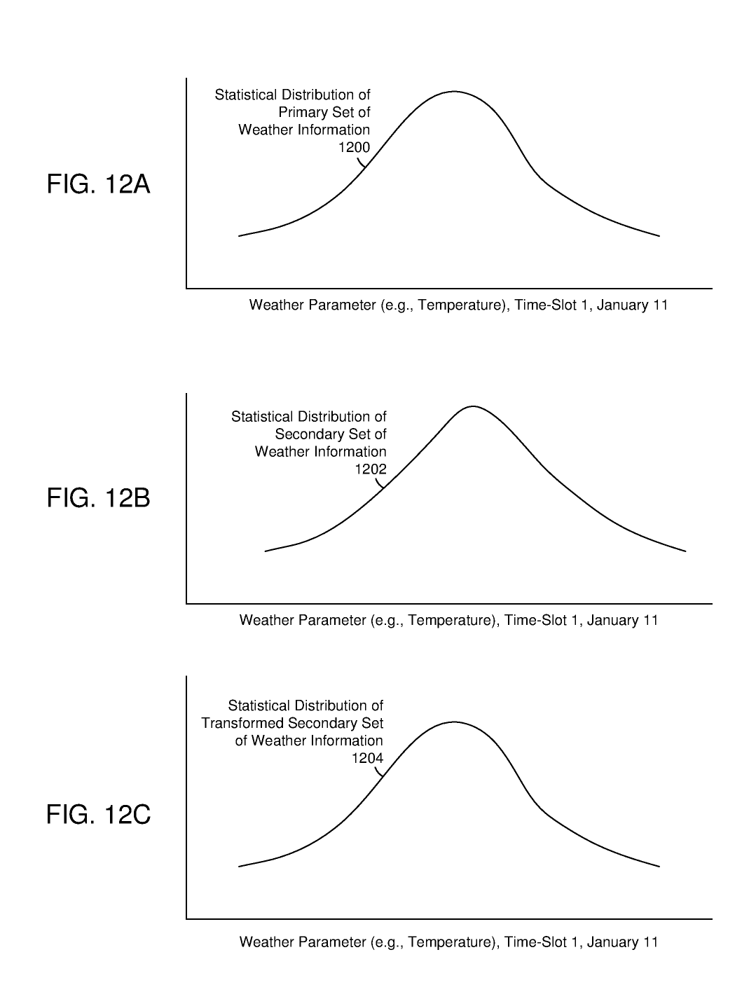

Engine 1116 may be configured to adjust a statistical distribution of a transformed set of weather information 1114 to more closely match a statistical distribution a respective primary set of weather information 1108. This is described below with reference to FIG. 12.

FIG. 12A illustrates a statistical distribution 1200 of measurements of a weather parameter (e.g., temperature) of a primary data set.

FIG. 12B illustrates a statistical distribution 1202 of measurements of the weather parameter of a secondary data set.

Where, as in this example, statistical distribution 1202 differs from statistical distribution 1200 (e.g., in terms of mean and/or standard deviation), the measurements of the secondary data set may be transformed with a model(s) as described herein such that a statistical distribution 1204 (FIG. 12C) of the transformed measurements matches statistical distribution 1200 (FIG. 12A). In other words, the measurements of the secondary data set are transformed to be statistically consistent with the measurements of the primary data set.

### Further Model Usage Examples

Further model usage examples are provided below for illustrative purposes.

Methods and systems disclosed herein are not, however, limited to the examples below.

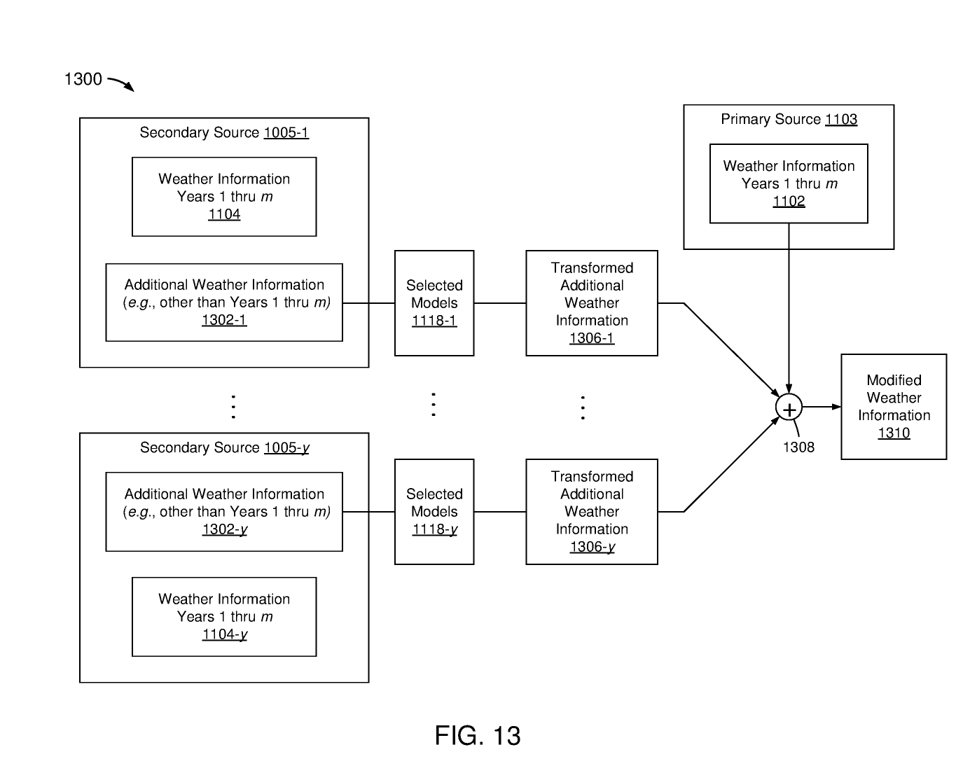

FIG. 13 is a block diagram of a system 1300 to supplement weather information of primary source 1103 with transformed weather information of one or more secondary sources 1105-1 through 1105-y.

System 1300 includes a set of models 1118 for each of one or more secondary sources 1105, such as described above with reference to FIG. 11.

Each set of models 1304 may include multiple time-slot specific models for each of multiple days of year, such as described in one or more examples herein. Each set of models 1304 may further include multiple parameter-specific models for each time-slot (e.g., separate models for temperature, pressure, humidity, wind velocity and/or other objective and/or subjective (e.g., wind chill factor) parameters).

Each set of selected models 1118 may be used to transform additional weather information 1302 of the respective secondary source 1105 into transformed weather information 1306 that is statistically consistent with weather information of primary source 1103.

At 1308, transformed weather information 1306, or a portion thereof, is added to and/or combined with weather information 1102 of primary source 1103 to provide a database of modified weather information 1310.

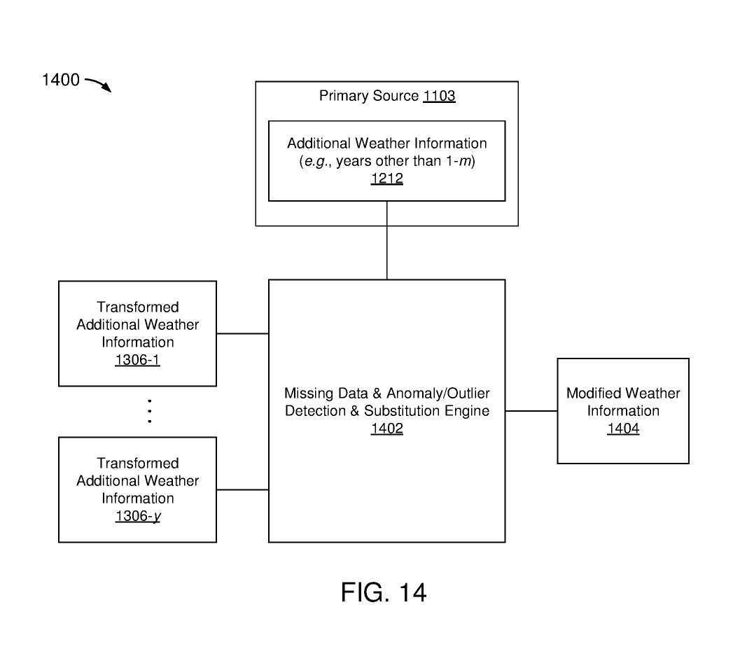

FIG. 14 is a block diagram of a system 1400 to identify and compensate for missing and/or outlier weather information/data points of primary source 1103.

System 1400 includes an engine 1402 to evaluate weather information of primary source 1103 relative to transformed additional weather information 1306, to detect/identify missing and/or anomalous/outlier weather information of primary source 1103, and to modify primary source 1103 with suitable weather information of transformed additional weather information 1306, to provide modified weather information 1404.

Engine 1402 may, for example, be configured to identify a time slot of a day of year for which weather information is absent from primary source 1103, and to supplement primary source 1103 with transformed additional weather information 1306 of the time slot of the day of year.

Alternatively, or additionally, engine 1402 may be configured to compare weather information of primary source 1302 with transformed additional weather information 1306, for a time slot of a day of year, to detect weather information of primary source 1103 that differs relatively significantly from transformed additional weather information 1306, for the time slot of the day of year. In this example, engine 1402 may be further configured to replace or substitute weather information of primary source 1103 with transformed additional weather information 1306, for the time slot of the day of year.

Methods and systems are disclosed herein with the aid of functional building blocks illustrating functions, features, and relationships thereof. At least some of the boundaries of these functional building blocks have been arbitrarily defined herein for the convenience of the description. Alternate boundaries may be defined so long as the specified functions and relationships thereof are appropriately performed. While various embodiments are disclosed herein, it should be understood that they are presented as examples. The scope of the claims should not be limited by any of the example embodiments disclosed herein.

What is claimed is:

1. A method, comprising, for each of multiple time slots of each of multiple days:
constructing a primary set and a secondary set of weather information from respective primary and secondary sources of weather information, including, for each of the primary set and the secondary set of weather information, aggregating weather information of the time slot over n consecutive days of each of m years to provide nxm time slots of weather information, where each of n and m is an integer greater than 1;
constructing multiple models, each to correlate between the primary set and the secondary set of weather information based on a respective one of multiple correlation techniques;
transforming at least a portion of the secondary set of weather information with each of the models to provide multiple respective transformed sets of weather data;
identifying one of the transformed sets of weather information as statistically consistent with the primary set of weather information based on a comparison of a statistical measure of the primary set of weather information to statistical measures of the respective transformed sets of weather information; and
selecting the model associated with the statistically consistent transformed set of weather information as a weather information conversion model for weather information of the respective time slot of the respective day of the secondary source.

2. The method of claim 1, wherein the aggregating includes, for each of the primary set and the secondary set of weather information:
aggregating weather information of the time slot and of j additional time slots adjacent to the first time slot, of each of the n consecutive days of each of the m years to provide the respective set of weather information with jxnxm time slots of weather information, where j is an integer greater than 1.

3. The method of claim 1, wherein the constructing includes centering the n consecutive days about the respective day.

4. The method of claim 1, further including:
transforming additional weather information of the secondary source based on the model to render the additional weather information statistically consistent with the weather information of the primary source, wherein the additional weather information includes weather information of the time slot of the day of a year other than the m years; and
combining the transformed additional weather information of the secondary source with weather information of the primary source.

5. The method of claim 1, further including:
transforming additional weather information of the secondary source based on the model, the time slot, and the day of year, to render the additional weather information of the secondary source statistically consistent with the weather information of the primary source;
identifying anomalous and/or missing weather information of the primary source based on the transformed additional weather information of the secondary source; and
modifying the weather information of the primary source based on the transformed additional weather information of the secondary source to compensate for the anomalous and/or missing weather information of the primary source.

6. The method of claim 1, wherein the constructing includes constructing a secondary set of weather information for each of multiple weather parameters, the method further including:
performing the determining, the transforming, and the selecting with respect to each of the weather parameters to provide multiple parameter-specific models for each time slot.

7. The method of claim 1, wherein:
the primary source of weather information includes weather information related to a first location;
the secondary source of weather information includes weather information related to a second location that is within a selectable geographic range of the first location.

8. The method of claim 1, wherein:
the first set of weather information includes one or more of observed and forecast weather information; and
the second set of weather information includes one or more of observed and forecast weather information.

9. An apparatus, comprising a processor and memory configured to, for each of multiple time slots of each of multiple days:
construct a primary set and a secondary set of weather information from respective primary and secondary sources of weather information, including, for each of the primary set and the secondary set of weather information, to aggregate weather information of the time slot over n consecutive days of each of m years to provide nxm time slots of weather information, where each of n and m is an integer greater than 1;
construct multiple models, each to correlate between the primary set and the secondary set of weather information based on a respective one of multiple correlation techniques;
transform at least a portion of the secondary set of weather information with each of the models to provide multiple respective transformed sets of weather data;
identify one of the transformed sets of weather information as statistically consistent with the primary set of weather information based on a comparison of a statistical measure of the primary set of weather information to statistical measures of the respective transformed sets of weather information; and
select the model associated with the statistically consistent transformed set of weather information as a weather information conversion model for weather information of the respective time slot of the respective day of the secondary source.

10. The apparatus of claim 9, wherein the processor and memory are further configured to, for each of the primary set and the secondary set of weather information:
aggregate weather information of the time slot and of j additional time slots adjacent to the first time slot, of each of the n consecutive days of each of the m years to provide the respective set of weather information with jxnxm time slots of weather information, where j is an integer greater than 1.

11. The apparatus of claim 9, wherein the processor and memory are further to center the n consecutive days about the respective day.

12. The apparatus of claim 9, wherein the processor and memory are further configured to:
transform additional weather information of the secondary source based on the model to render the additional weather information statistically consistent with the weather information of the primary source, wherein the additional weather information includes weather information of the time slot of the day of a year other than the m years; and
combine the transformed additional weather information of the secondary source with weather information of the primary source.

13. The apparatus of claim 9, wherein the processor and memory are further configured to:
transform additional weather information of the secondary source based on the model, the time slot, and the day of year, to render the additional weather information of the secondary source statistically consistent with the weather information of the primary source;
identify anomalous and/or missing weather information of the primary source based on the transformed additional weather information of the secondary source;
and modify the weather information of the primary source based on the transformed additional weather information of the secondary source to compensate for the anomalous and/or missing weather information of the primary source.

14. The apparatus of claim 9, wherein the processor and memory are further configured to:
construct a secondary set of weather information for each of multiple weather parameters; and
perform the determining, the transforming, and the selecting with respect to each of the weather parameters to provide multiple parameter-specific models for each time slot.

15. A non-transitory computer readable medium encoded with a computer program that includes instructions to cause a processor to, for each of multiple time slots of each of multiple days:
construct a primary set and a secondary set of weather information from respective primary and secondary sources of weather information, including, for each of the primary set and the secondary set of weather information, to aggregate weather information of the time slot over n consecutive days of each of m years to provide nxm time slots of weather information, where each of n and m is an integer greater than 1;
construct multiple models, each to correlate between the primary set and the secondary set of weather information based on a respective one of multiple correlation techniques;
transform at least a portion of the secondary set of weather information with each of the models to provide multiple respective transformed sets of weather data;
identify one of the transformed sets of weather information as statistically consistent with the primary set of weather information based on a comparison of a statistical measure of the primary set of weather information to statistical measures of the respective transformed sets of weather information; and
select the model associated with the statistically consistent transformed set of weather information as a weather information conversion model for weather information of the respective time slot of the respective day of the secondary source.

16. The non-transitory computer readable medium of claim 15, further including instructions to cause the processor to, for each of the primary set and the secondary set of weather information:
aggregate weather information of the time slot and of j additional time slots adjacent to the first time slot, of each of the n consecutive days of each of the m years to provide the respective set of weather information with jxnxm time slots of weather information, where j is an integer greater than 1.

17. The non-transitory computer readable medium of claim 15, further including instructions to cause the processor to center the n consecutive days about the respective day.

18. The non-transitory computer readable medium of claim 15, further including instructions to cause the processor to:
transform additional weather information of the secondary source based on the model to render the additional weather information statistically consistent with the weather information of the primary source, wherein the additional weather information includes weather information of the time slot of the day of a year other than the m years; and
combine the transformed additional weather information of the secondary source with weather information of the primary source.

19. The non-transitory computer readable medium of claim 15, further including instructions to cause the processor to:
transform additional weather information of the secondary source based on the model, the time slot, and the day of year, to render the additional weather information of the secondary source statistically consistent with the weather information of the primary source;
identify anomalous and/or missing weather information of the primary source based on the transformed additional weather information of the secondary source; and
modify the weather information of the primary source based on the transformed additional weather information of the secondary source to compensate for the anomalous and/or missing weather information of the primary source.

20. The non-transitory computer readable medium of claim 15, further including instructions to cause the processor to:
construct a secondary set of weather information for each of multiple weather parameters; and
perform the determining, the transforming, and the selecting with respect to each of the weather parameters to provide multiple parameter-specific models for each time slot.
